(19) United States
(12) Patent Application Publication
(10) Pub. No.: US 2026/0002469 A1
(43) Pub. Date: Jan. 1, 2026

(54) ASSEMBLY FOR AN ELECTRICALLY HYBRIDISED TURBINE ENGINE

(71) Applicant: SAFRAN, Paris (FR)

(72) Inventors: Anne Marie LIENHARDT, Moissy-Cramayel (FR); Guillaume François Daniel BIDAN, Moissy-Cramayel (FR); Florent Jean-Arnaud ROUGIER, Moissy-Cramayel (FR)

(73) Assignee: SAFRAN, Paris (FR)

(21) Appl. No.: 18/881,412

(22) PCT Filed: Jul. 5, 2023
(86) PCT No.: PCT/FR2023/051030

§ 371 Date: Jan. 6, 2025

(30) Foreign Application Priority Data
Jul. 7, 2022 (FR) FR2206972

(51) Int. Cl. F02C 6/00; B64D 27/33; H02K 7/18

(52) U.S. Cl. CPC F02C 6/00; B64D 27/33; H02K 7/183; B64D 2221/00

(57) ABSTRACT

This disclosure relates to an assembly for a gas turbine engine comprising:
a first rotary spool (222, 262, 282);
a second rotary spool (20, 220, 260, 280); and
an electrical system (4) comprising:
   a bus (40);
   a first generator (411);
   a second generator (421);
   a first converter (410);
   a second converter (420); and
   a control device (412, 422, 432, 4000).

### FIELD OF THE INVENTION

This application relates to the field of gas turbine engines, in particular aircraft engines. More precisely, this application relates to the management of the supply of power to electrical loads of an engine and/or of an aircraft.

### PRIOR ART

An aircraft may comprise at least one engine and each of the engine and the aircraft may comprise electrical loads and/or electrical power supply sources. An electrical system may connect the loads, the sources and the engine to one another to allow electrical exchanges between these different parts. The loads may be supplied by mechanical offtake from the engine, and the engine may be assisted by electrical offtake from the sources, either at take-off or in flight. When the engine is in operation, the power requirements of the loads may vary, sometimes abruptly. On the other hand, the mechanical offtake from the engine must comply with a certain number of limitations, to ensure the optimization of this engine's operation. For example, at take-off it is preferable to limit the offtake from the low-pressure spool of the engine, which is in extremely heavy use to provide thrust and in this regard cannot be allowed to experience oscillations in thrust related to a variable mechanical offtake from the electrical system.

### SUMMARY OF THE INVENTION

One aim of the invention is to allow an aircraft engine to meet the power requirements of electrical loads while complying with its own operational limitations.

In this regard, provision is made, according to an aspect of this disclosure, for an assembly for an electrically hybridized gas turbine engine, comprising:
a first rotary spool forming a first source of mechanical power;
a second rotary spool forming a second source of mechanical power; and
an electrical system comprising:
   an electrical power supply bus provided to be connected to at least one electrical load and configured to supply an electrical power to the load in the form of a DC signal;
   a plurality of electrical power sources configured to transfer an electrical power to the bus and comprising:
      a first AC generator connected to the first rotary spool to take off a mechanical power from the first rotary spool and convert it into electrical power able to be transferred to the bus;
      a second AC generator connected to the second rotary spool to take off a mechanical power from the second rotary spool and convert it into electrical power able to be transferred to the bus;
   a plurality of converters connected to the plurality of electrical power sources and to the bus, the converters being configured to regulate the voltage of the bus based on an electrical power supplied by the electrical power sources and comprising:
      a first converter connected to the first AC generator, the first converter being connected to the bus and configured to regulate the voltage of the bus based on an electrical power supplied by the first AC generator;
      a second converter connected to the second AC generator, the second converter being connected to the bus and configured to regulate the voltage of the bus based on an electrical power supplied by the second AC generator; and
   a control device connected to the converters and configured to drive the converters for the purpose of compensating for a variation in a voltage of the bus by successive use of the electrical power sources according to a determined offtake sequence.

Advantageously, but optionally, the assembly may comprise at least one of the following features, taken alone or in any combination whatsoever:
in this assembly:
the plurality of electrical power sources comprises a DC source;
the plurality of converters comprises a third converter connected to the DC source and to the bus, the third converter being configured to regulate the voltage of the bus based on a power supplied by the DC source; and
the control device is connected to the third converter;
each converter comprises a control member configured to drive the converter, the control device further comprising a central member configured to:
   receive a setpoint relating to the offtake sequence; and
   transmit to each of the control members a command signal for the driving of the converters, the command signal having been generated from the setpoint;
the control device is moreover configured to drive the converters as a function of an offtake threshold specific to each of the electrical power sources;
the control device is moreover configured to:
receive a control signal representative of a correction associated with a difference between a measurement of a voltage of the bus and a reference, the difference being representative of the variation in the voltage of the bus; and
perform a frequency filtering of the control signal so as to determine at least one low-frequency component and at least one high-frequency component, the driving of the converters being implemented based on at least one out of the low-frequency component and the high-frequency component;
the control device is configured to drive the converters based on the low-frequency component;
the control device is configured to drive the converters based on the high-frequency component; and
the control device is further configured to drive the converters as a function of a setpoint of distribution of offtake between the electrical power sources.

According to another aspect of this disclosure, provision is made for a method for controlling an assembly as previously described, the method being implemented by the control device and comprising the driving of the converters for the purpose of compensating for a variation in a voltage of the bus by successive use of the electrical power sources according to a predetermined offtake sequence.

Advantageously, but optionally, in the control method as previously described, the driving according to a predetermined offtake sequence comprises the use of a preferred electrical power source from among the plurality of electrical power sources until the offtake limit of the preferred electrical power source is reached, the other electrical power sources not being used, then the successive use of other electrical power sources once the offtake limit has been exceeded.

Alternatively, in the control method as previously described, the driving according to a predetermined offtake sequence comprises the use of a preferred electrical power source from among the plurality of electrical power sources until the offtake limit of the preferred electrical power source is reached, the other electrical power sources being moreover used at a minimum power threshold, then the successive use of other electrical power sources once the offtake limit has been exceeded.

### DESCRIPTION OF THE FIGURES

Other features, aims and advantages of the invention will become apparent from the following description, which is purely illustrative and non-limiting, and which must be read with reference to the appended drawings on which:

FIG. 1 schematically illustrates an aircraft.

FIG. 2 schematically illustrates an engine.

FIG. 3 schematically illustrates an electrical system according to an aspect of this disclosure.

FIG. 4 is a flow chart illustrating the steps of a method for controlling an electrical system according to this disclosure.

FIG. 5 illustrates the operation of a part of an electrical system according to an aspect of this disclosure.

FIG. 6 illustrates the operation of another part of an electrical system according to another aspect of this disclosure.

On all the figures, similar elements bear identical reference numbers.

### DETAILED DESCRIPTION OF THE INVENTION

### Aircraft

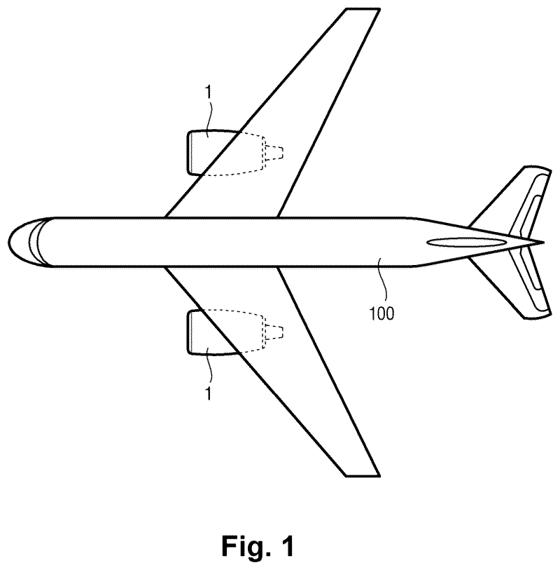

FIG. 1 illustrates an aircraft 100 comprising at least one propulsion assembly 1, in this case two propulsion assemblies 1. The aircraft 100 shown is an airplane, civil or military, but could be any other type of aircraft 100, such as a helicopter. The propulsion assemblies 1 are added on and attached to the airplane 100, each under one wing of the airplane 100, as can be seen on FIG. 1. This is however non-limiting, since at least one propulsion assembly 1 can also be mounted on the wing of the airplane or aft of its fuselage.

The aircraft 100 also comprises a plurality of electrical loads (or receivers) (not shown). Each electrical load is a device supplied with electrical energy and which can be configured to convert the electrical energy supplied thereto into another form of energy, such as for example heat or mechanical energy. Non-limiting examples of electrical loads of the aircraft 100 are: an electric motor, a heating and/or climate control system, a compressor, etc. These electrical loads in particular make it possible to ensure a certain number of functionalities, in flight and on the ground alike, such as the pressurization and/or lighting of the cabin of the aircraft 100, the operation of the cockpit, etc.

To supply these electrical loads with electrical energy, the aircraft 100 comprises a plurality of electrical networks, including at least one DC network. Each electrical network typically comprises a set of electrical conductors, typically a set of a wire (or wires) or a bar (or bars) and/or an assembly of a wire (or wires) or one or more printed circuit boards and/or any apparatus serving to conduct electricity. The DC network only permits the flow of electrical energy in the form of a DC signal.

The electrical energy consumed by the electrical loads can, at least in part, be produced by the engine 2 of the propulsion assembly 1, described in more detail hereinafter, and more precisely by mechanical offtake from the rotary spools BP, HP of the engine 2.

### Propulsion Assembly

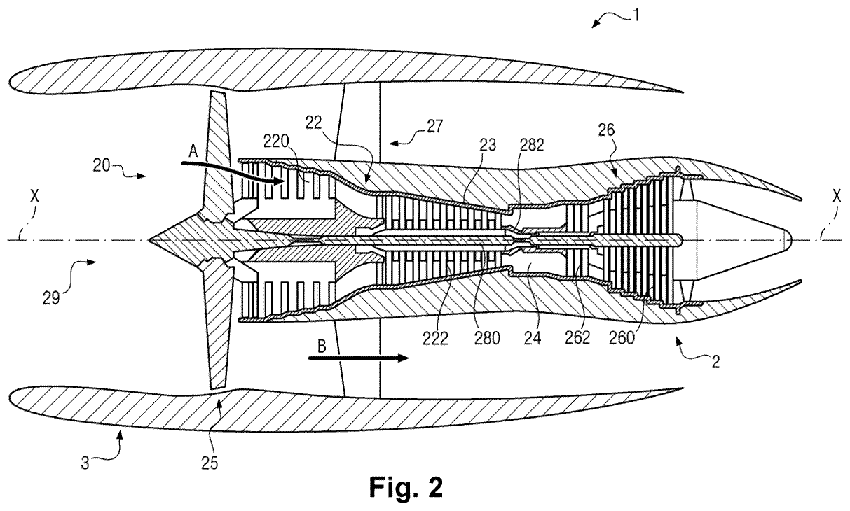

FIG. 2 illustrates a propulsion assembly 1 having a longitudinal axis X-X, and comprising an engine 2, which is a gas turbine engine, and a nacelle 3 surrounding the engine 2.

The propulsion assembly 1 is intended to be mounted on an aircraft 100, for example as illustrated on FIG. 1. In this regard, the propulsion assembly 1 may comprise a pylon (not 10 shown) intended to connect the propulsion assembly 1 to a part of the aircraft 100.

The engine 2 illustrated on FIG. 2 is a twin-spool, bypass turbojet engine with direct driving of the fan 20. This is however non-limiting since the engine 2 may include a different number of spools and/or streams, and/or be another type of turbojet engine, such as a turbojet engine with driving of the fan via a reducer, or a turboprop engine. Similarly, that which is described is applicable to all types of gas turbine engine, i.e. of systems allowing a transfer of energy between a rotary part and a fluid.

Unless otherwise specified, the terms “upstream” and “downstream” are used with reference to the overall direction of air flow through the propulsion assembly 1 in operation. Similarly, an axial direction is equivalent to the direction of the longitudinal axis X-X and a radial direction is a direction orthogonal to the longitudinal axis X-X and intersecting the longitudinal axis X-X. Moreover, an axial plane is a plane containing the longitudinal axis X-X and a radial plane is a plane orthogonal to the longitudinal axis X-X. A circumference should be understood to mean a circle belonging to a radial plane and the center of which belongs to the longitudinal axis X-X. A tangential or circumferential direction is a direction tangent to a circumference: it is orthogonal to the longitudinal axis X-X but does not pass through the longitudinal axis X-X. Finally, the adjectives “inside” (or “inner”) and “outside” (or “outer”) are used with reference to a radial direction such that the inside part of an element is, along a radial direction, closer to the longitudinal axis X-X than the outside part of the same element.

As can be seen on FIG. 2, the engine 2 comprises, from upstream to downstream, a fan 20, a compression section 22 comprising a low-pressure compressor 220 and a high-pressure compressor 222, a combustion chamber 24 and an expansion section 26 comprising a high-pressure turbine 262 and a low-pressure turbine 260. Each of the low-pressure compressor 220, the high-pressure compressor 222, the high-pressure turbine 262 and the low-pressure turbine 260 comprises a rotor part and a stator part, the rotor part being able to be rotationally driven with respect to the stator part about the longitudinal axis X-X. The fan 20, the rotor part of the low-pressure compressor 220, and the rotor part of the low-pressure turbine 260 are connected to one another by a low-pressure shaft 280 extending along the longitudinal axis X-X, thus forming a low-pressure spool (spool BP) which is a first rotary spool. The rotor part of the high-pressure compressor 222 and the rotor part of the high-pressure turbine 262 are connected to one another by a high-pressure shaft 282 also extending along the longitudinal axis X-X, around the low-pressure shaft 280, thus forming a high-pressure spool (spool HP) which is a second rotary spool. As can be seen on FIG. 2, the compression section 22, the combustion chamber 24 and the expansion section 26 are surrounded by an engine casing 23, to which are connected the stator parts of the low-pressure compressor 220, of the high-pressure compressor 222, of the high-pressure turbine 262 and of the low-pressure turbine 260, while the fan 20 is surrounded by a fan casing 25. The engine casing 23 and the fan casing 25 are connected to one another by profiled arms 27 forming OGVs (Outlet Guide Vanes) circumferentially distributed all around the longitudinal axis X-X. Provision may be made for least some of these arms 27 to be structural parts. The longitudinal axis X-X defines the axis of rotation for the fan 20, the rotor parts of the compression section 22 and the rotor parts of the expansion section 26, in other words for the spool BP and the spool HP, which are each able to be rotationally driven about the longitudinal axis X-X with respect to the engine casing 23 and to the fan casing 25.

The nacelle 3 extends radially outside the engine 2, all around the longitudinal axis X-X, so as to surround both the engine casing 25 and the engine casing 23, and to define, with a downstream part of the engine casing 23, a downstream part of a secondary air path B, the upstream part of the secondary air path B being defined by the fan casing 25 and an upstream part of the engine casing 23. The upstream part of the nacelle 3 further defines an air inlet 29 through which the fan 20 suctions the stream of air circulating through the propulsion assembly 1. The nacelle 3 is secured to the fan casing 25 and added and attached to the aircraft 100 by means of the pylon.

The engine 2 may also comprise at least one Accessory Gear Box (AGB), typically housed in a cavity fashioned in the nacelle 3. The accessory gear box comprises an assembly of gears used to rotationally drive a plurality of shafts about their own axis, accessories being mounted on these shafts to draw useful mechanical power from their rotation. The assembly of gears is itself driven using a Radial Drive Shaft (RDS) connecting, optionally by way of a transfer gearbox (not shown), the accessory gearbox to at least one from among the high-pressure spool HP and the low-pressure spool BP, typically by meshing with at least one from among the high-pressure shaft 282 and the low-pressure shaft 280. In this regard, the radial drive shaft can extend inside a longitudinal cavity fashioned in one of the arms 27. In this way, a mechanical power is able to be taken off from at least one from among the high-pressure spool HP and the low-pressure spool BP to be delivered to at least one of the accessories by way of the accessory gearbox.

The engine 2 can itself also comprise a plurality of electrical loads (not shown), such as a starter, variable geometries or de-icing systems, which must also be supplied with electrical energy. The supply of power to at least some of these electrical loads can take the form of a DC signal, typically a DC voltage.

In operation, the fan 20 suctions a stream of air, a portion of which, circulating in a primary air path A, is, successively, compressed in the compression section 22, ignited within the combustion chamber 24 and expanded in the expansion section 26 before being expelled from the engine 2. The primary air path A traverses the engine casing 23 from end to end. Another portion of the stream of air circulates in the secondary air path B which has an elongated annular shape surrounding the engine casing 23, the air suctioned by the fan 20 being guided by the outlet guide vanes then expelled from the propulsion assembly 1. In this way, the propulsion assembly 1 generates a thrust. This thrust can, for example, be used by the aircraft 100 on which the propulsion assembly 1 is added and attached.

### Electrical System

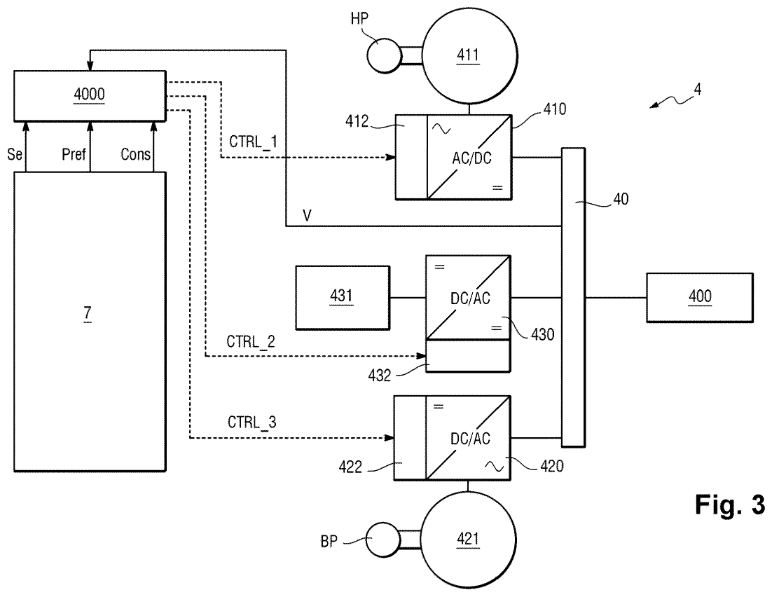

FIG. 3 illustrates an electrical system 4 distributed between the propulsion assembly 1 and the aircraft 100 to supply electrical energy to the electrical loads 400 of the engine 2 and/or of the aircraft 100, typically by means of the DC network. The electrical system 4 in particular makes it possible to embody the interface between the rotary spools BP, HP of the engine 2 and the electrical network of the aircraft 100. The electrical system is in particular configured to meet the electrical power requirements of the loads 400 of the aircraft 100 and/or of the engine 2 by mechanical offtake from the engine 2, and to assist with the take-off and/or in-flight operation of the engine 2 using electrical sources of the aircraft 100 and/or of the engine 2. In other words, the engine 2 is electrically hybridized.

The electrical system 4 comprises an electrical bus 40, or electrical power supply bus 40, connected to at least one electrical load 400 of the aircraft 100 and/or of the engine 2, preferably an assembly of several loads 400 of the aircraft 100 and/or of the engine 2, the bus 40 being configured to supply an electrical power to the load 400 in the form of a DC signal, particularly to meet its power requirements. In other words, the bus 40 is configured to permit the circulation of electrical energy in the form of a DC signal. The bus 40 may, for example, comprise a set of electrical conductors, typically a set of a wire (or wires) or a bar (or bars) and/or an assembly of a wire (or wires) and/or one or more printed circuit boards and/or any apparatus serving to conduct electricity.

The electrical system 4 further comprises several electrical converters 410, 420, 430, each connected to a respective electrical source 411, 421, 431, i.e. to an element configured to supply an electrical power. The electrical sources 411, 421, 431 may be an AC generator 411, 421, and/or a DC generator 431. The AC generator 411, 421 and the DC source 431 may belong to the engine 2, i.e. be driven at the same time as the engine 2, or even be driven by the engine 2. In this case these are electrical sources 411, 421, 431 of the engine 2. Hence the DC source 431 is not necessarily located in the engine 2 and can, for example, be housed in a pylon making it possible to attach the engine 2 to the aircraft 100. Alternatively, the DC source 431 belongs to the aircraft 100, i.e. it is controlled at the same time as the aircraft 100. As can be seen on FIG. 3, the electrical system 4 may thus comprise a first converter 410 connected to a first AC generator 411, a second converter 420 connected to a second AC generator 421 and, optionally, a third converter 430 connected to a DC source 431. The third converter 430 and the DC source 431 are optional in the sense that, in certain embodiments, they are absent or, in other embodiments, the DC source 431 is unavailable. In addition, each of the converters 410, 420, 430 is, as can be seen on FIG. 3, connected to the bus 40. Hence, at least one, if not each, of the converters 410, 420, 430 is configured to regulate the voltage of the bus 40 based on, i.e. using, an electrical power supplied by the electrical source(s) 411, 421, 431 to which the converters 410, 420, 430 are connected. The number and type of the converters 410, 420, 430 and electrical sources 411, 421, 431 is, of course, non-limiting.

The voltage regulation of the bus 40 is critical. Specifically, while the variation over time of the electrical voltage within the bus 40, during the operation of the electrical system 4, can intermittently vary around a given nominal value, it must still remain within the limits of an envelope, which guarantees that all the elements which are connected to the bus 40 are working correctly. The envelope in fact defines the upper and lower limits of excursion of the voltage, as a function of time, during the operation of the electrical system 4. The envelope may comprise limits defined for normal and/or abnormal operating conditions, and which surround, symmetrically or otherwise, a nominal voltage level of the bus 40. In a diagram (not shown) providing the variation in voltage as a function of time, a limit of an envelope is typically represented as a line, broken or otherwise. Preferably, even if the limit does not at first define a constant voltage value, particularly during the characteristic time taken to turn on (or start) the electrical system 4 or else during the time taken to establish a permanent rating in the case of a power transient, it is common for the limit to then define a constant voltage, in order to guarantee the operational stability of the bus 40 and, hence, of the electrical system 4. Such an envelope can, for example, be defined in a standard relating to the quality of the electrical system 4 and/or of the DC network, but can also be defined by a specifications book of a vehicle of aircraft type to which the electrical system 4 is connected, typically the stipulations of the manufacturer of the aircraft 100 and/or of the engine 2 into which the electrical system 4 is integrated.

On the other hand, the voltage regulation of the bus 40 makes it possible to meet the power requirements on behalf of the loads 400 connected to the bus 40. Typically, when the power taken off by at least one load 400 from the bus 40 is greater than the quantity of power injected into the bus 40 by at least one converter 410, 420, 430, the voltage of the bus 40 significantly decreases. Conversely, when the quantity of power injected by at least one converter 410, 420, 430 into the bus 40 is greater than the quantity of power taken off from the bus 40 by at least one load 400, the voltage of the bus 40 increases. Thus, regulating the voltage of the bus 40 makes it possible, besides ensuring the safety of the electrical system 4, to meet the power requirements of the loads 400. In other words, each of the converters 410, 420, 430 is configured to constantly adapt the power it injects into or takes off from the bus 40, according to the voltage of the bus 40, so as to exactly meet the power requirements of the loads 400 connected to the bus 40.

This injection or offtake of power into or from the bus 40 by the converters 410, 420, 430 is in particular made possible by their connection to the electrical sources 411, 421, 431. Hence, at least one, if not each, of the AC generators 411, 421 is connected to a rotary spool BP, HP, of the engine 2 to allow an exchange of mechanical and/or electrical power between the rotary spool BP, HP and the AC generator 411, 421, preferably to take off a mechanical power from the rotary spool BP, HP and convert it into an electrical power, which electrical power is then delivered to the first converter 410 and/or to the second converter 420 to be injected into the bus 40. As the electrical power provided by the AC generators 411, 421 is in the form of an AC signal, each of the first converter 410 and of the second converter 420 is configured to reversibly convert this AC signal into a DC signal suitable for being injected into, then circulating through, the bus 40. Similarly, the DC source 431 can deliver a power in the form of a DC signal to the third converter 430, which will still convert it, also reversibly, to shape it according to the limitations specific to the bus 40, then inject it into the bus 40. Each, or at least one, of the AC generators 411, 421 can, for example, be a wound-rotor synchronous machine, typically comprising three stages, known as a Variable Frequency Generator (VFG), driven by at least one from among the high-pressure shaft 282 and the low-pressure shaft 280 of the engine 2, typically by way of the accessory gearbox. Other types of electric machine may be envisioned, such as, preferably, Permanent-Magnet Synchronous Machine Drives (PMSM), which in particular have the advantage of having a smaller mass, or induction machines or variable-reluctance machines. Preferably, the first AC generator 411 is connected to the spool HP, while the second AC generator 421 is connected to the spool BP, 280. The DC source 431 can, meanwhile, comprise a battery, a supercapacitor, a DC generator and/or a fuel cell. The DC source 431 in particular makes it possible to relieve the rotary spools BP, HP, or take over from them, when, for example, the offtake level demanded to meet the power requirement of the loads 400 is too high, but also makes it possible to absorb certain dynamics, such as abrupt variations, of the behavior of the loads 400.

FIG. 3 also illustrates that the electrical system 4 comprises a control device 412, 422, 432, 4000, connected to at least one, if not each, of the converters 410, 420, 430.

The control device 412, 422, 432, 4000 illustrated on FIG. 3 comprises a central member 4000 and a plurality of control members 412, 422, 432, each of the control members 412, 422, 432 being connected to (or incorporated into) one of the converters 410, 420, 430. Alternatively, the control device 412, 422, 432 may comprise only the plurality of control members 412, 422, 432, each of the control members 412, 422, 432 being connected to (or incorporated into) one of the converters 410, 420, 430.

The control device 412, 422, 432, 4000 is moreover advantageously configured to receive a signal V representative of a measurement of a voltage of the bus 40. To do this, the control device 412, 422, 432, 4000 can be connected to the bus 40 or to a voltage sensor connected to the bus 40, and receive from the bus 40 (or from this sensor) the signal V. This signal V can be received by way of a physical or wireless link. This signal V in particular represents the variation in the power requirements of the loads 400 connected to the bus 40. Typically, when a load 400 suddenly requires a significant amount of power to be taken off from the bus 40, due to the response time of the electrical system 4 to supply the bus 40 with the power needed to compensate for the taken-off power, the voltage of the bus 40 will abruptly drop, and this drop will be escalated to the control device 412, 422, 432, 4000 by way of the signal V. In the same way, when a load 400 suddenly sheds a significant amount of power onto the bus 40, due to the response time of the electrical system 4 to remove from the bus 40 the power needed to compensate for this shedding, the voltage of the bus 40 will abruptly increase, and this increase will be escalated to the control device 412, 422, 432, 4000 by way of the signal V. Hence, the signal V is typically a time signal, i.e. providing (or representing) the variation in the voltage of the bus 40 as a function of time. Many loads 400, particularly so-called “active” loads 400, may have this type of dynamic behavior, which can moreover vary over the different flight phases.

The variations in the voltage of the bus 40 are compensated for by the action of the converters 410, 420, 430, an action which therefore tracks the variation in voltage, however sudden and fluctuating it may be. This is why this action is coordinated by the control device 412, 422, 432, 4000 to keep the voltage of the bus 40 within the envelopes allowing a stable operation of the electrical system 4.

To do so, each of the converters 410, 420, 430 receives from the control device 412, 422, 432, 4000 a setpoint of its own, and from which the converter 410, 420, 430 regulates the voltage of the bus 40. Combining the voltage regulations of each converter 410, 420, 430 thus makes it possible to constantly keep track of the power requirements of the loads 400.

Thus, the control device 412, 422, 432, 4000 can be configured to drive the converters 410, 420, 430 according to a sequence of offtake from the rotary spools BP, HP, and where applicable of offtake from the DC source 431, for the purpose of compensating for a variation in a voltage of the bus 40. In other words, the compensation for a variation in the voltage of the bus 40 expressing a power requirement of a load 400 is preferably done by one of the converters 410, 420, 430, up to a certain acceptable limit of offtake from the corresponding electrical source 411, 421, 431, then by one (or more) of the other converters 410, 420, 430 to compensate for the rest of the variation for which the preferred converter 410, 420, 430 would not have been able to compensate. In other words, the control device 412, 422, 432, 4000 makes a decision to determine which electrical source 411, 421, 431 will be used first to regulate the voltage of the bus 40, the other electrical sources 411, 421, 431 not being used, then, when this first-used electrical source 411, 421, 431 can no longer respond since it has reached its acceptable power offtake limit, the control device 412, 422, 432, 4000 will make a decision to determine which out of the other electrical sources 411, 421, 431 takes over, and so on for as long as the voltage regulation of the bus 40 requires an injection of additional power into the bus 40 and the acceptable limits of the successive electrical sources 411, 421, 431 are reached. In other words, at this point, the electrical system 4 in place can no longer generate the necessary power for the loads 400. This allows the control device 412, 422, 432, 4000 to favor, instead of prohibiting, offtake from such or such a rotary spool BP, HP during the operation of the engine 2, in order to optimize the operating point of the engine 2, by managing, on a case-per-case basis, the impact that can be generated by the offtake from a rotary spool BP, HP on the performance of this rotary spool BP, HP. This optimization can also advantageously include the management of the performance of the DC source 431.

In an embodiment, the control device 412, 422, 432, 4000 may be configured such that, even if an electrical source 411, 421, 431 is used first, according to the offtake sequence, the other electrical sources 411, 421, 431 are not unused. In other words, in this embodiment, the majority of the regulation of the voltage of the bus 40 is done using the preferred electrical source 411, 421, 431, and a minority of the regulation is done by the other electrical sources 411, 421, 431, until the preferred electrical source 411, 421, 431 has reached its acceptable power offtake limit. Thus the non-preferred electrical sources 411, 421, 431 still receive a minimum amount of use, their rating oscillating around a minimum of electrical power exchanged with their respective converter 410, 420, 430, which avoids an oscillation around a zero electrical power value, which would be liable to damage the electrical system 4.

Moreover, the control device 412, 422, 432, 4000 can be configured to perform a frequency filtering of a control current i, which is representative of the action required of the converters 410, 420, 430 to correct a difference recorded between the signal V and a reference V_ref, for example associated with the envelope, as described in more detail hereinafter. In reality, the control current i is representative (or associated) with the variation in voltage of the bus 40 recorded via the signal V.

However, the high-frequency component of the variation in the voltage of the bus 40 requires an immediate and rapid response from the electrical system 4, while its low-frequency component requires a background, long-term response from the electrical system 4. Typically, during the operation of the engine 2, the power requested by the loads 400 varies with a slow dynamic (low-frequency component), but can experience abrupt and intermittent power draws (high-frequency component) from certain loads 400, for example electrical actuators of the flaps of the wings of the aircraft 100. Hence, it can be appropriate to drive the converters 410, 420, 430 by distinguishing between these different components, by way of the frequency filtering of the control current i.

In general, the low-frequency component of the variation in the voltage of the bus 40 will determine the operating point of the engine 2, while the high-frequency component will be absorbed by the inertia of the rotary spools BP, HP. To do so, the control device 412, 422, 432, 4000 can moreover be configured to drive each of the converters 410, 420, 430 for the purpose of compensating for a part of the high-frequency component and a part of the low-frequency component. In other words, each converter 410, 420, 430 takes its share of the response to the power requirements expressed by the loads 400 and manifesting as the variation in the voltage of the bus 40. More accurately, each of the converters 410, 420, 430 can thus receive from the control device 412, 422, 432, 4000 a setpoint of its own, and from which the converter 410, 420, 430 regulates the voltage of the bus 40. The combination of the voltage regulations of each converter 410, 420, 430 in this case allows an optimization of the operating point of the engine by constantly keeping track of the power requirements of the loads 400. Thus the rotary spool BP, HP, which would be the most sensitive to rapid fluctuations in mechanical power offtake at certain operating points, can advantageously be load-shedded in favor of the other rotary spool BP, HP or of the DC source 431, in order to allow an optimization of the operating point of the engine 2.

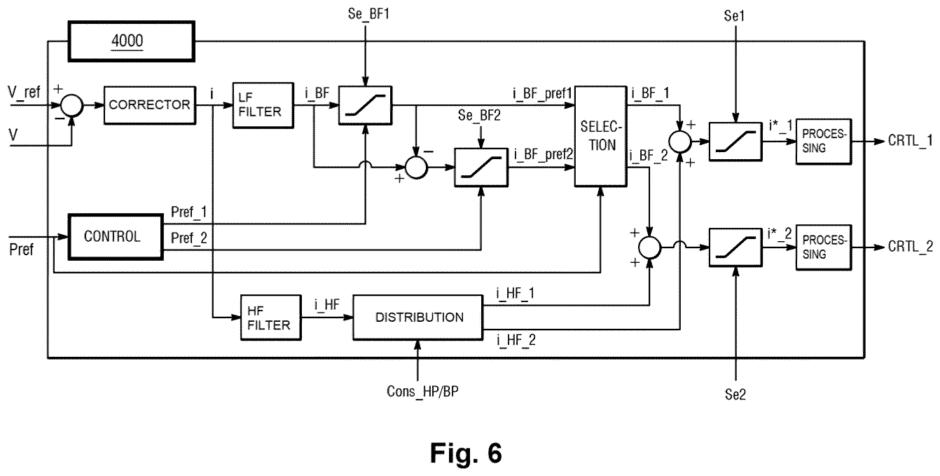

In this regard, the different strategies mentioned previously can be implemented by the control device 412, 422, 432, 4000 in combination, as will be described in more detail with particular reference to FIG. 6. Typically, the control device 412, 422, 432, 4000 can be configured to drive the converters 410, 420, 430 according to a sequence of offtake from the rotary spools BP, HP, for the purpose of compensating for the low-frequency component, and according to the same, or another, offtake sequence for the purpose of compensating for the high-frequency component. Alternatively, or additionally, the control device 412, 422, 432, 4000 can be configured to drive the converters 410, 420, 430 according to a setpoint of distribution of offtake between the rotary spools BP, HP, for the purpose of compensating for the low-frequency component, and according to the same, or another, setpoint of distribution of offtake for the purpose of compensating for the high-frequency component.

In the electrical system 4 illustrated on FIG. 3, it is the central member 4000 which is, in particular, configured to receive then process the signal V, as illustrated in more detail on FIG. 6. Moreover, the central member 4000 is configured to transmit to each of the control members 412, 422, 432 a command signal CTRL_1, CTRL_2, CTRL_3, which can typically take the form of a command current, for the driving of the converters 410, 420, 430. In the electrical system 4 illustrated on FIG. 3, the control is therefore done in a centralized manner. Alternatively, when the control device 412, 422, 432 comprises only the control members 412, 422, 432, each of the control members 412, 422, 432 is configured to, in particular, receive and process the signal V, and drive the converter 410, 420, 430. In other words, the control is then provided in a decentralized manner.

FIG. 3 moreover shows the presence of a general controller 7, which can for example be all or part of the system providing the interface between the cockpit of the aircraft 100 and the engine 2 (or FADEC or Full Authority Digital Engine Control), and typically be the control unit of the engine 2 (or ECU for Electronic Control Unit), which is incorporated into the FADEC. The general controller 7 is connected to the control device 412, 422, 432, 4000, in this case to the central member 4000, but could alternatively be directly connected to each of the control members 412, 422, 432 when the central member 4000 is not present. In this case, the functions fulfilled by the central member 4000 are then done locally in the control members 412, 422, 432, i.e. done by the general controller 7. The general controller 7 determines not only the offtake sequence, but also additional limitations to be observed by the electrical system 4 to meet the power requirements of the loads 400. Thus, the general controller 7 can transmit to the control device 412, 422, 432, 4000 a setpoint Pref relating to the offtake sequence, but also a setpoint Cons of distribution of offtake between the rotary spools BP, HP and the DC source 431, and/or a threshold Se1, Se2, Se3 of maximum offtake from at least one, if not each, of the rotary spools BP, HP and of the DC source 431, the threshold Se1, Se2, Se3 being, optionally, specific to each rotary spool BP, HP and to the DC source 431. More precisely, the setpoint Pref relating to the offtake sequence provides the order in which the generators 411, 421 and the DC source 431 must be used, while the distribution setpoint Cons indicates to the control device 412, 422, 432, 4000 the way in which the entirety of the power to be taken off from the engine 2 to meet the requirements of the loads 400 must be distributed between the rotary spools BP, HP, and the DC source 431, and can typically take the form of a percentage. The offtake thresholds Se1, Se2, Se3 meanwhile supply, for each of the electrical sources 411, 421, 431, the maximum value of the power that the control device 412, 422, 432, 4000 is permitted to have taken off by their respective converter 410, 420, 430; i.e. a first maximum value of power that can be taken off from the engine 2 by the first converter 410, via the first AC generator 411, a second maximum value of power that can be taken off from the engine 2 by the second converter 420, via the second AC generator 421, and a third maximum value of power that can be taken off from the DC source 431 by the third converter 430. The threshold Se3 associated with the DC source 431 can typically take the form of a charging or discharging current offtake limit if the DC source 431 is a battery. The control device 412, 422, 432, 4000 is then configured to drive the converters 410, 420, 430 as a function of this setpoint Pref relating to the offtake sequence, this distribution setpoint Cons and/or these thresholds Se1, Se2, Se3. In particular, as will be described in more detail hereinafter, the parts of the high-frequency component and of the low-frequency component which are compensated for by the converter 410, 420, 430 are determined using the distribution setpoint Cons and/or the thresholds Se1, Se2, Se3.

The setpoint Pref relating to the offtake sequence, the distribution setpoint Cons and/or the offtake thresholds Se1, Se2, Se3 transmitted by the general controller 7 may vary over time and make it possible to ensure that each of the rotary spools BP, HP and the DC source 431 supply the necessary power to the loads while optimizing the operating point of the engine 2. For example, during take-off, which is a flight phase requiring a large amount of thrust from the fan 20, i.e. a phase during which a large amount of power is transmitted by the spool BP to the fan 20, the high-frequency part of the power will be preferably, or even totally, taken off from the spool HP, the low-frequency part of the power being preferably, or even totally, taken off from the spool BP, in order to avoid oscillations in thrust on the spool BP. Contrariwise, during certain flight phases in which the operability limits of the high-pressure body HP are reached, it is preferable to take off more power from the low-pressure spool BP. Whatever the circumstances, this setpoint Pref relating to the offtake sequence, this distribution setpoint Cons and/or these offtake thresholds Se1, Se2, Se3 can also prove necessary insofar as the mechanical offtake has different consequences according to the rotary spool BP, HP from which the power is taken off.

### Control Method

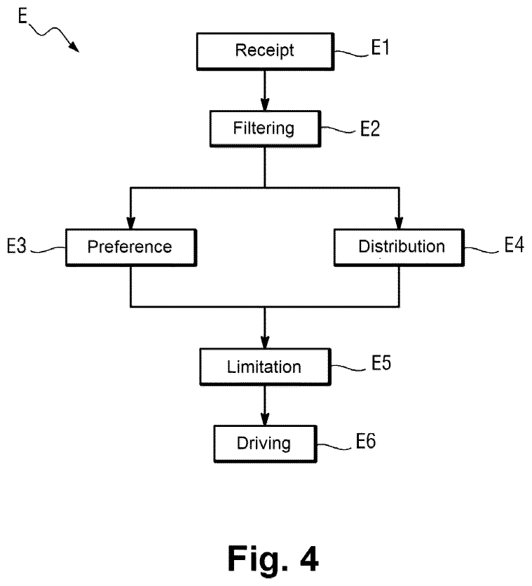

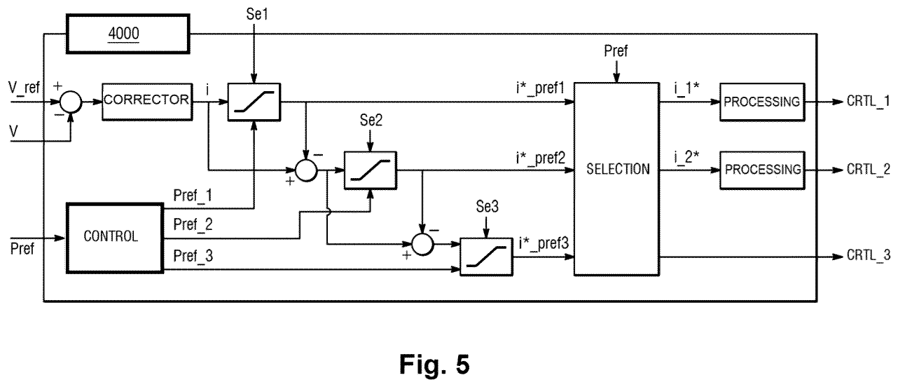

FIG. 4 more precisely illustrates the control method E which can be implemented by the control device 412, 422, 432, 4000 to make it possible to respond in real time to the power requirements of the loads 400, whatever the operating phase of the engine 2, while complying with the constraints specific to the engine 2, and particularly to its rotary spools BP, HP. FIG. 5 and FIG. 6 illustrate this control method E implemented within the central member 4000, but this is however non-limiting since this control method can be implemented within one, if not each, of the control members 412, 422, 432. This control method E allows the electrical system 4 to correct a recorded difference (or error) between a reference V_ref, which depends on the voltage envelope of the bus 40 and represents the state in which the bus 40 should be for normal operation, and a measurement of the voltage V of the bus 40, which itself represents the actual requirements of the loads 400 as they express it by injection or offtake of power into or from the bus 40. In other words, this control method E, by correcting this difference between the reference V_ref and the measurement of the voltage V of the bus 40, ensures that the power requirements of the loads 400 are satisfied by the voltage regulation of the bus 40.

More precisely, as can be seen on FIG. 5 and FIG. 6, a signal V representative of a measurement of the voltage of the bus 40 is received. This signal V can then be compared to a reference V_ref. If there is no difference between a reference V_ref and a measured signal V, it is because the voltage of the bus 40 does not have to be regulated. On the other hand, if a difference is observed, i.e. the voltage of the bus 40 has undergone a variation, it is necessary for the voltage of the bus 40 to be regulated. To do this, it is necessary to drive the electrical sources 411, 421, 431 for the purpose of carrying out this voltage regulation. This driving (or command) can, for example, consist in the transmission of a setpoint current, a power setpoint or even a torque setpoint. These setpoints will determine the way in which the electrical system 4, and more precisely the electrical sources 411, 421, 431, must adapt its operation to successfully conduct this voltage regulation. In this case, a setpoint control current i, easier to manipulate by the control device 412, 422, 432, 4000, whether it is the central member 4000 or control members 412, 422, 432, can advantageously be generated then processed as a function of the error recorded in the signal V with respect to the reference V_ref. The processing can advantageously be implemented by a corrector of proportional-integral type. Thus, the control current i is representative of the correction to be made by the electrical system 4 to reduce, or even cancel out, the difference between reference V_ref and measured signal V, and thus compensate for the variation in the voltage of the bus 40. However, this control current i only sets the general setpoint to be adopted by the electrical system 4, without identifying the roles that each of the members of the electrical system 4, and more precisely the electrical sources 411, 421, 431, will have to play in the voltage regulation.

In this regard, the control current i, is received E1 by a filtering member which can itself undergo a frequency filtering E2 so as to determine therein at least one low-frequency component i_BF and one high-frequency component i_HF, components i_BF, i_HF which are, in fact, respectively representative of the low-frequency component and the high-frequency component of the variation in the voltage on the bus 40. Hence, the variation in the control current i is representative of the variation in the voltage of the bus 40, by way of the measured signal V. To do this, as illustrated on FIG. 6, the control current i is, for example, duplicated, since each of the twins of the control current i undergoes a frequency filtering, one low-frequency and the other high-frequency. The term “high-frequency” should be understood to mean frequencies greater than or equal to 1 Hz and less than or equal to 1000 Hz, while the term “low frequency” refers to frequencies less than 1 Hz.

As can be seen on FIG. 5 and FIG. 6, whether the control current i has undergone frequency filtering E2 (FIG. 6) or not (FIG. 5), the setpoint Pref relating to the offtake sequence is used E3 to determine Pref_1 the preferred electrical source 411, 421, 431 to be used to compensate for the variation in voltage on the bus 40. This preferred setpoint Pref_1 can advantageously be combined E5 with the offtake thresholds Se1, Se2, Se3, which can moreover, optionally, be adapted Se1 _BF, Se2_BF to the offtake for the low-frequency component or for the high-frequency component of the variation in the voltage of the bus 40, as is the case on FIG. 6. In this way, if the quantity of power to be injected into the bus 40 does not exceed its offtake limit, it is only the preferred electrical source 411, 421, 431 which is used. Alternatively, while the electrical source 411, 421, 431 is mainly (but not solely) used, the other electrical sources 411, 421, 431 are used to the extent of a minimum threshold, which can for example be transmitted by the general controller 7, such that the sum of the power to be injected into the bus 40 make it possible to compensate for the recorded difference between the reference V_ref and the measurement of the voltage V of the bus 40. However, whatever the method of implementation being considered (i.e. with sole use of the preferred electrical source 411, 421, 431 or not), if the quantity of power to be injected into the bus 40 to provide this compensation exceeds the offtake limit of the preferred electrical source 411, 421, 431, this preferred electrical source 411, 421, 431 will have to take off power at its limit, and the top-up power has to be taken off by the other electrical sources 411, 421, 431. Here again the setpoint Pref relating to the offtake sequence is used to determine Pref_2 the non-preferable electrical source 411, 421, 431 to be used first, then second Pref_3, in this regard, the logic being repeated until the entire variation in the voltage of the bus 40 has been compensated for, each electrical source 411, 421, 431 used to do this being, or not being, at the limit of the offtake they can provide. Typically, as can be seen on FIG. 5 and on FIG. 6, this logic can be implemented by modifying the filtered (i_BF) or unfiltered (i) control currents. The control currents i*_pref1, i*_pref2, i*_pref3, i_BF_pref1, i_BF_pref2 resulting therefrom are then selected to be reallocated i*_1, i*_2, i_BF_1, i_BF_2 to each electrical source 411, 421, 431, while being able to undergo one last processing beforehand, to match the specific limitations of the converters 410, 420, 430.

FIG. 6 illustrates that the preferred offtake logic is applied to the low-frequency component i_BF, while the high-frequency component i_HF is subject to an offtake distribution logic. This can prove advantageous insofar as the low-frequency component of the variation in the voltage of the bus 40 tends to influence the operating point of the engine 2, while the high-frequency component of the variation in the voltage of the bus 40 has more of an influence on the regulation of the bus 40. However, this is not limiting, since both the low-frequency component i_BF and the high-frequency component i_HF can be subject to the preferred logic, or the offtake distribution logic, or it is the high-frequency component i_HF which can be subject to the preferred offtake logic, while the low-frequency component i_BF is subject to the offtake distribution logic. Moreover, FIG. 6 illustrates that only the AC generators 411, 412 are used, but everything described with reference to FIG. 6 can of course be extended to the case in which the DC source 431 is also present.

On FIG. 6, based on a distribution setpoint Cons received from the general controller 7, a part i_HF_1, i_HF_2 dedicated to each converter 410, 420, 430 is determined E4 for the high-frequency component i_HF. This distribution setpoint Cons in this case takes the form of a distribution setpoint Cons_HP/BP imposing the distribution of offtake between spool HP and spool BP. Typically, the filtered control current is thus modified i_1_HF, i_2_HF as a function of the distribution setpoint Cons. The FIG. 6 also illustrates that the control currents i_BF_1, i_BF_2 resulting from the preferred offtake logic and the control currents i_1_HF, i_2_HF resulting from the distribution logic are summed, where applicable combined E5 again with the offtake threshold Se_1, Se_2 corresponding to each of the generators 411, 421 used to ensure that the latter will not exceed its offtake limit, and advantageously processed i*_1, i*_2 again to match the limitations specific to the converters 410, 420, 430.

Each converter 410, 420, 430 is driven E6, for example using the final control current CTRL_1, CTRL_2, CTRL_3, for the purpose of compensating for its part of the variation in the voltage.

1. An assembly for an electrically hybridized gas turbine engine, comprising:
first rotary spool forming a first source of mechanical power;
second rotary spool forming a second source of mechanical power; and
an electrical system comprising:
an electrical power supply bus provided to be connected to at least one electrical load and configured to supply an electrical power to the load in the form of a DC signal;
a plurality of electrical power sources configured to transfer an electrical power to the bus and comprising:
a first AC generator connected to the first rotary spool to take off a mechanical power from the first rotary spool and the mechanical power into electrical power able to be transferred to the bus;
a second AC generator connected to the second rotary spool to take off a mechanical power from the second rotary spool and convert the mechanical power into electrical power able to be transferred to the bus;
a plurality of converters connected to the plurality of electrical power sources and to the bus, the plurality of converters being configured to regulate voltage of the bus based on an electrical power supplied by the plurality of electrical power sources and comprising:
a first converter connected to the first AC generator, the first converter being connected to the bus and configured to regulate the voltage of the bus based on an electrical power supplied by the first AC generator;
a second converter connected to the second AC generator, the second converter being connected to the bus and configured to regulate the voltage of the bus based on an electrical power supplied by the second AC generator; and
a control device connected to the first converter and the second converter, the control device being configured to drive the first converter and the second converter to compensate for a variation in the voltage of the bus by successive use of each electrical power source of the plurality of electrical power sources according to a determined offtake sequence.

2. The assembly as claimed in claim 1, wherein:
the plurality of electrical power sources comprises a DC source;
the plurality of converters comprises a third converter connected to the DC source and to the bus, the third converter being configured to regulate the voltage of the bus based on a power supplied by the DC source; and
the control device is connected to the third converter.

3. The assembly of claim 1, wherein each the first converter and the second converter comprise respectively a first control member configured to drive the first converter and a second control member configured to drive the second converter, the control device further comprising a central member configured to:
receive a setpoint relating to the determined offtake sequence; and
transmit to the first control member a command signal to drive the first converter and to the second control member a command signal to drive the second converter, the command signal having been generated from the setpoint.

4. The assembly of claim 1, wherein the control device is further configured to drive the plurality of converters as a function of an offtake threshold specific to each electrical power source of the plurality electrical power sources.

5. The assembly of claim 1, wherein the control device is further configured to:
receive a control signal representative of a correction associated with a difference between a measurement of a voltage of the bus and a reference, the difference being representative of the variation in the voltage of the bus;
perform a frequency filtering of the control signal so as to determine at least one low-frequency component and at least one high-frequency component; and
drive the plurality of converters based on at least one out of the low-frequency component and the high-frequency component.

6. The assembly of claim 5, wherein the control device is configured to drive the plurality of converters based on the at least one low-frequency component.

7. The assembly of claim 5, wherein the control device is configured to drive the plurality of converters based on the at least one high-frequency component.

8. The assembly of claim 1, wherein the control device is further configured to drive the plurality of converters as a function of a setpoint of distribution of offtake between the plurality of electrical power sources.

9. A method for controlling the assembly according to claim 1, the method being implemented by the control device and comprising driving the plurality of converters to compensate for a variation in a voltage of the bus by successive use of each electrical power source of the plurality of electrical power sources according to a predetermined offtake sequence.

10. The method as claimed in claim 9, wherein the driving the plurality of converters to compensate for a variation in a voltage of the bus by successive use of each electrical power source of the plurality of electrical power sources according to the predetermined offtake sequence comprises:
using a preferred electrical power source from among the plurality of electrical power sources until an offtake limit of the preferred electrical power source is reached; then
using successively each electrical power source of the plurality of electrical power sources distinct from the preferred electrical power source once the offtake limit has been exceeded.

11. The method as claimed in claim 9, wherein driving the plurality of converters to compensate for a variation in a voltage of the bus by successive use of each electrical power source of the plurality of electrical power sources according to the predetermined offtake sequence comprises:
using a preferred electrical power source from among the plurality of electrical power sources until an offtake limit of the preferred electrical power source is reached, each electrical power source of the plurality of power sources distinct from the preferred electrical power source being used at a minimum power threshold; then
using successively each electrical power source of the plurality of electrical power sources distinct from the preferred electrical power source once the offtake limit has been exceeded.

12. The assembly of claim 2, wherein the first converter, the second converter and the third converter comprise respectively a first control member configured to drive the first converter, a second control member configured to drive the second converter and a third control member configured to drive the third converter, the control device further comprising a central member configured to:
receive a setpoint relating to the determined offtake sequence; and
transmit to the first control member a command signal to drive the first converter, to the second control member a command signal to drive the second converter and to the third control member a command signal to drive the third converter, the command signal having been generated from the setpoint.
